(19) United States
(12) Patent Application Publication
(10) Pub. No.: US 2004/0266621 A1
(43) Pub. Date: Dec. 30, 2004

(54) Synergistic boric acid combination pest control composition

(76) Inventor: Michael Howard West, Senatobia, MS (US)

Correspondence Address: MICHAEL HOWARD WEST, 54 SOUTH CROCKETT ROAD, SENATOBIA, MS, 38668, US

(21) Appl. No.: 10/602,106

(22) Filed: Jun. 24, 2003

(51) Int. Cl. A01N 25/26; A01N 25/00; A01N 59/14

(52) U.S. Cl. 504/116.1; 424/659

(57) ABSTRACT

A pest control composition comprising

(a) about 0.05% to about 75% boric acid;

(b) about 0.05% to about 75% of a dispersant prepared by combining an aqueous metal salt with a fatty amine wherein the metal salt is selected from the group consisting of aluminum, cobalt, iron, manganese, nickel, silver, and zirconium; and

(c) about 0.01% to about 25% of an organic pesticide.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO A MICROFICHE APPENDIX

NOT APPLICABLE

### BACKGROUND OF THE INVENTION

The field of endeavor to which this invention pertains relates to the control of pests including weeds, fungi, insects, and bacteria. The problems solved are excess usage of pest control agents, and pest resistance to organic biocides.

Boric acid acts as a herbicide, fungicide, insecticide, and bactericide; however, its effectiveness is not sufficient to compete with organic pest control products in many markets. The synergism of my invention allows boric acid to be used in many more markets, and the use of boric acid with organics solves pest resistance problems common to organics.

I have found that dispersants created by reacting fatty amines with aqueous aluminum, cobalt, iron, manganese, nickel, silver, and zirconium salts allow for boric acid to be combined with organic pesticides in aqueous dispersions. In the absence of alkaline or anionic components, these combinations exhibit synergistic pest control performance. Using the organic with inorganic boric acid provides assurance that resistant pest populations are unlikely to develop. Other compatible ingredients may be added to my composition.

### BRIEF SUMMARY OF THE INVENTION

The present invention relates to a pest control composition comprising

(a) about 0.05% to about 75% boric acid;

(b) about 0.05% to about 75% of a dispersant prepared by combining an aqueous metal salt with a fatty amine wherein the metal salt is selected from the group consisting of aluminum, cobalt, iron, manganese, nickel, silver, and zirconium; and

(c) about 0.01% to about 25% of an organic pesticide.

The object of my invention is to provide synergistic pest control with less total pesticide usage, and to prevent development of resistant pest populations.

### DETAILED DESCRIPTION OF THE INVENTION

The preferred embodiment employs powdered boric acid, the dispersant prepared by combining aqueous aluminum, cobalt, iron, manganese, nickel, silver, and zirconium nitrates or chlorides with dimethylcocoamine in about 1 to 1 weight ratios, and an organic pesticide selected from the group consisting of a tetrachloroisophthalonitrile fungicide, an isothiazoline fungicide, a synthetic pyrethroid insecticide, an organic phosphate insecticide, a fipronil insecticide, a glyphosate herbicide, and a formaldehyde release bactericide. Especially preferred is chlorothalonil and propiconazole. The preferred process for making the composition consists of blending the aqueous metal salt with dimethylcocoamine, adding the boric acid, and then adding the organic pesticide. Concentrates or treating solutions may be prepared; hence, the wide rage of percentages for the components of my composition. The preferred use rate for pest control is about 0.5% boric acid, 0.5% dispersant, and 0.025% organic pesticide diluted in water. It is preferred the organic pesticides be combined with the other components if they are chemically stable, and soluble, otherwise they should be added separately to the treating solution.

Fungicides according to my preferred embodiment were tested by spraying a concrete basement wall for mold control evaluation, insecticide preparations were tested by spraying wooden cabinets and evaluating insect control when food was placed in those cabinets, herbicide preparations were evaluated by spraying a plot containing mixed weed species, and bactericide preparations were evaluated by their ability to prevents spoilage of broth. When tested in this manner the composition of my invention gave better pest control than boric acid or organic pesticide used alone at twice the rate.

I claim:

1. A pest control composition comprising
(a) about 0.05% to about 75% boric acid;
(b) about 0.05% to about 75% of a dispersant prepared by combining an aqueous metal salt with a fatty amine wherein the metal salt is selected from the group consisting of aluminum, cobalt, iron, manganese, nickel, silver, and zirconium; and
(c) about 0.01% to about 25% of an organic pesticide.

2. The composition of claim 1 wherein the organic pesticide is chlorothalonil.

3. The composition of claim 1 wherein the organic pesticide is propiconazole.

4. The composition of claim 1 wherein the metal salt is aluminum nitrate.

5. The composition of claim 1 wherein the fatty amine is dimethylcocoamine.
